(19) United States
(12) Patent Application Publication
(10) Pub. No.: US 2004/0182256 A1
(43) Pub. Date: Sep. 23, 2004

(54) Taco frying clip

(76) Inventor: Melton John Losoya, Woodland, CA (US)

Correspondence Address: DANIEL P. MAGUIRE, 423 E ST., DAVIS, CA, 95616, US

(21) Appl. No.: 10/392,154

(22) Filed: Mar. 19, 2003

(51) Int. Cl. A47J 43/18

(52) U.S. Cl. 99/426

(57) ABSTRACT

A clip for closing taco shells during deep frying is disclosed. The clip includes a two-piece body for holding the taco shell, handles for opening and closing the body, and a spring mechanism to bias the body into a closed position.

### BACKGROUND OF THE INVENTION

1. Field of the Invention

This invention relates to devices for holding food as it is being fried.

2. General Background

In traditional Mexican cooking, tacos are prepared by deep frying soft tortilla shells that have been pre-filled with taco filling. The taco shells must somehow be held in a closed position while they are being fried, otherwise the meat or other filling will fall out of the shell and into the cooking oil.

In the past, toothpicks have been threaded through the taco shells to temporarily close them during frying. However, there are a number of disadvantages to this method. First, it is time consuming to thread the toothpicks through the shell. Second, the toothpicks are prone to fall out, spilling the taco contents into the hot oil. Third, the toothpicks are not very hygienic, and sometimes they are reused.

Thus, there is a need for a device that can securely but temporarily hold taco shells in a closed position while they are being fried.

### SUMMARY OF THE INVENTION

The present invention is a clip that holds taco shells closed while they are being fried.

### BRIEF DESCRIPTION OF THE DRAWINGS

FIG. 1 is a perspective view of a taco that is being held in a closed position using a clip according to an embodiment of the present invention.

FIG. 2 is a side view of a taco that is being held in a closed position using a clip according to an embodiment of the present invention.

FIG. 3 is a side view of a clip according to an embodiment of the present invention.

FIG. 4 is a top view of a clip according to an embodiment of the present invention.

FIG. 5 is a front view of a clip according to an embodiment of the present invention.

FIG. 6 is a bottom view of a clip according to an embodiment of the present invention.

### DETAILED DESCRIPTION

The present invention is a clip for use in closing soft taco shells while they are being deep fried. The clip has a two-piece body 10, handles 20, and a spring mechanism 30.

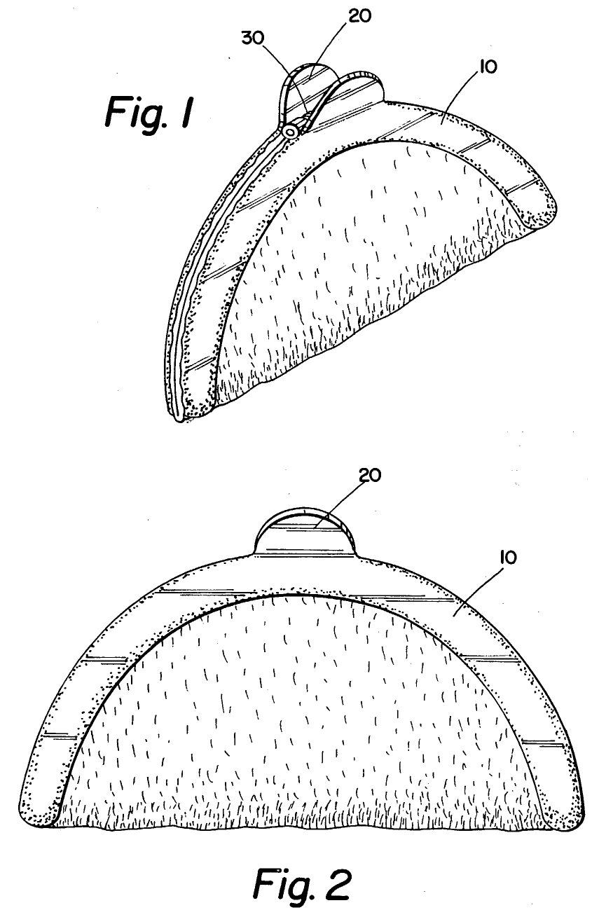

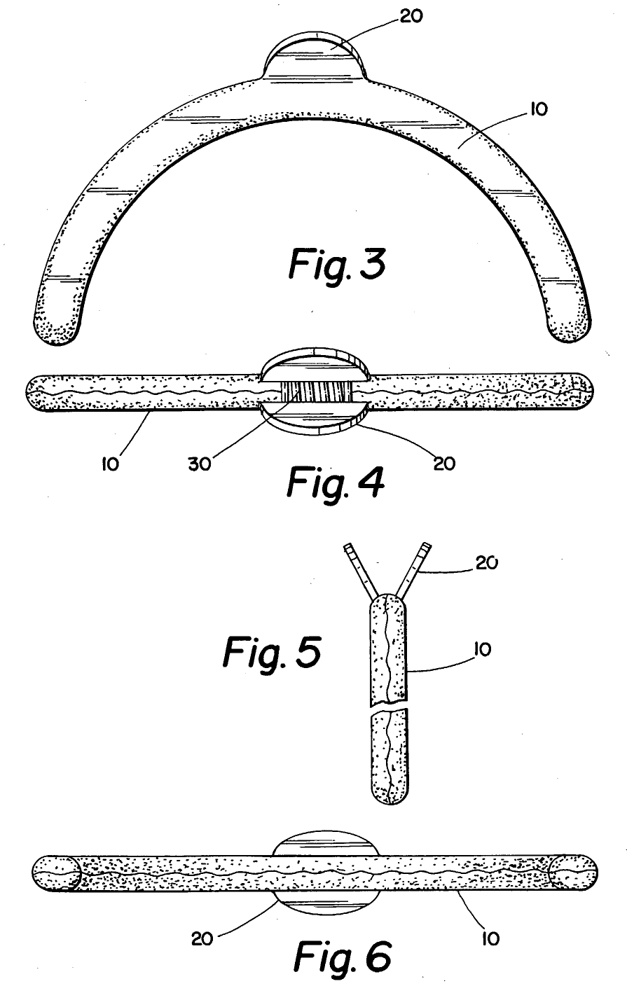

As shown best in FIGS. 1, 2, and 3, the body is crescent-shaped or u-shaped, so as to completely encompass the outer edge of the folded soft taco shell. The body has two arms, one on each side, and the taco is held between these arms, as depicted in FIGS. 1 and 2. When the handles 20 are squeezed, the two arms of the body 10 separate, allowing the taco shell to be inserted between the arms. When the handles 20 are not being squeezed, the arms of the body fit together. See. FIGS. 4 and 6.

The handles 20 are disposed atop the body 10, and are used to open and close the arms. See FIG. 1. The handles 20 can be integral with the body, or they can be fastened to the body through mechanical means or adhesives.

The spring mechanism 30 is used to bias the arms of the body 10 into a closed position, thereby holding the taco shell firmly closed while it is being fried. Standard spring mechanisms, such as those used on potato-chip clips, binder clips, etc. can be used.

The clip according to the present invention can be made of a number of materials, including but not limited to metal and plastic or styrene materials. In one embodiment, the clip is made of a heat-tolerant plastic, such as polyetheretherketone, which is sold under the trade name “PEEK.”

Unlike toothpicks, the present invention may be reused, so long as it is properly cleaned between uses.

A rack or other holder may be used to hold taco frying clips according to the present invention. When a new taco clip is needed, the chef can simply remove one from the rack. The supply of clips on the rack can be replenished with “used” clips after they have been cleaned. This method is much more convenient and efficient than the traditional toothpick method.

One skilled in the art will appreciate that the present invention can be practiced by other than the preferred embodiments, which are presented for purposes of illustration and not of limitation.

I claim:

1.) A re-usable clip for holding tortilla shells closed during frying.

2.) A clip for holding tortilla shells closed during frying, comprising:
a body having arms, whereby said arms hold the food;
a spring mechanism attached to said body; and
a handle for controlling said spring mechanism.

3.) The clip according to claim 2, wherein said arms are shaped and sized to match a folded tortilla.

4.) The clip according to claim 3, wherein said body is made of plastic.

5.) The clip according to claim 4, wherein said body is made of polyetheretherketone.

6.) The clip according to claim 3, wherein said body is made of metal.

7.) The clip according to claim 3, wherein said spring mechanism biases said arms into a closed position.

8.) The clip according to claim 7, wherein said arms are opened by squeezing said handles.

9.) The clip according to claim 8, wherein said handles are made of plastic.

10.) The clip according to claim 9, wherein said arms are substantially U-shaped.

11.) The clip according to claim 10, wherein said handles are integral with said body.

12.) A method of preparing a taco shell, comprising:
filling a tortilla with taco filling;
folding said tortilla; and
temporarily closing said tortilla with a taco frying clip.

13.) The method according to claim 12, additionally comprising frying said tortilla.

14.) The method of claim 13, additionally comprising removing said clip from said taco after said frying.

15.) The method of claim 14, additionally comprising cleaning said clip for reuse.

16.) The method according to claim 15, additionally comprising removing a taco frying clip for use from a rack containing such clips.
